(19) United States
(12) Patent Application Publication
(10) Pub. No.: US 2025/0075787 A1
(43) Pub. Date: Mar. 6, 2025

(54) GEAR AND GEAR DAMPER

(71) Applicant: NOK CORPORATION, Tokyo (JP)

(72) Inventors: Hirotaka ONO, Saihaku-gun (JP); Yu AKAI, Saihaku-gun (JP); Yutaka ORIOKU, Saihaku-gun (JP)

(21) Appl. No.: 18/812,304

(22) Filed: Aug. 22, 2024

(30) Foreign Application Priority Data
Aug. 29, 2023 (JP) 2023-138643
Mar. 7, 2024 (JP) 2024-035222

(51) Int. Cl. F16H 55/16; F16H 55/17

(52) U.S. Cl. CPC F16H 55/16; F16H 55/17

(57) ABSTRACT

Provided are a gear and a gear damper that enable noise reduction and offer excellent versatility. A gear includes: a metal gear body; and a damper unit that is provided to cover at least a meshing surface of each of teeth in the gear body and has a surface made of an elastic body. As a result, the gear enables noise reduction and offers excellent versatility.

### CROSS-REFERENCE TO RELATED APPLICATIONS

This application claims the benefit and priority of Japanese Application No. 2024-035222, filed Mar. 7, 2024 and Japanese Application No. 2023-138643, filed Aug. 29, 2023. The entire disclosures of each of the above applications are incorporated herein by reference.

### FIELD

The present disclosure relates to a gear and a gear damper.

### BACKGROUND

Technologies for providing dampers in various gears to reduce noise have been known.

For example, Japanese Patent Application Laid-open No. H04-362346 discloses a technology for incorporating a damper, which includes an outer ring, an inner ring, and an annular elastic body provided between the outer ring and the inner ring, into a gear. In this technology, the structure of the gear becomes complicated, and the gear is likely to be upsized, resulting in poor versatility.

### SUMMARY

An object of the present disclosure is to provide a gear and a gear damper that enable noise reduction and offer excellent versatility.

The present disclosure employs the following means to solve the above problem.

That is, a gear according to the present disclosure includes: a metal gear body; and a damper unit that is provided to cover at least a meshing surface of each of teeth in the gear body and has a surface made of an elastic body.

According to the present disclosure, noise reduction is achievable by a damper unit. Further, the damper unit is provided to cover at least the meshing surface of a tooth. Therefore, compared to a configuration where a damper is incorporated into a gear, it is possible to prevent the structure of a gear body from becoming complicated and eliminate the need for upsizing a gear.

The damper unit may be a rubber layer provided on a surface of the meshing surface.

If this configuration is employed, a rubber layer only needs to be provided on the surface of the meshing surface of a tooth. Therefore, the configuration of a damper unit is simple.

The damper unit may be the rubber layer formed by applying rubber glue to the meshing surface and then allowing the rubber glue to dry.

The damper unit may suitably be the rubber layer formed by applying rubber glue to the meshing surface, allowing the rubber glue to dry, and then vulcanizing the rubber glue through heating.

The damper unit may be a damper member fitted and fixed to the tooth.

If this configuration is employed, a damper member only needs to be fitted to a tooth. Therefore, it is possible to prevent the structure of a gear body from becoming complicated.

The damper member may include a thin plate unit made of a metal thin plate and rubber layers provided on both surfaces of the thin plate unit.

Both lateral surfaces of the tooth may be configured so that a distance between both the lateral surfaces increases toward a tip end surface of the tooth, and a pair of surfaces of the damper member that face both the lateral surfaces of the tooth may be configured so that a distance between the pair of surfaces increases toward the tip end surface of the tooth.

As a result, even if a centrifugal force or the like is applied to a damper member, it is possible to prevent the damper member from disengaging from a tooth.

The damper member may be individually fitted and fixed to each of the teeth.

The damper member may have a plurality of fitting units that are collectively fitted and fixed to a plurality of the teeth, and an expansion/contraction unit that enables slight adjustment of a mutual distance may be provided between the fitting units adjacent to each other.

As a result, it is possible to reduce the number of operation times for fitting a damper member to a tooth. Further, an improvement in fitting operability is achievable by an expansion/contraction unit.

Further, a gear damper according to the present disclosure is fitted and fixed to a tooth in a metal gear body and is provided to cover at least a meshing surface of the tooth, and has a surface made of an elastic body.

The gear damper may include a thin plate unit made of a metal thin plate and rubber layers provided on both surfaces of the thin plate unit.

Both lateral surfaces of the tooth may be configured so that a distance between both the lateral surfaces increases toward a tip end surface of the tooth, and a pair of surfaces that face both the lateral surfaces of the tooth may be configured so that a distance between the pair of surfaces increases toward the tip end surface of the tooth.

As a result, even if a centrifugal force or the like is applied to a damper member, it is possible to prevent the damper member from disengaging from a tooth.

The gear damper may be individually fitted and fixed to each of the teeth.

The gear damper may have a plurality of fitting units that are collectively fitted and fixed to a plurality of the teeth, and an expansion/contraction unit that enables slight adjustment of a mutual distance may be provided between the fitting units adjacent to each other.

Note that the above respective configurations may be employed in combination as much as possible.

As described above, the present disclosure enables noise reduction and offers excellent versatility.

### BRIEF DESCRIPTION OF THE DRAWINGS

FIGS. 1A and 1B are external views of a gear according to a first embodiment of the present disclosure;

FIG. 2 is an external view of a gear according to a second embodiment of the present disclosure;

FIGS. 3A to 3C are external views of a gear damper according to the second embodiment of the present disclosure;

FIG. 4 is a view illustrating the fitting state of the gear damper according to the second embodiment of the present disclosure;

FIG. 5 is an external view of a gear according to a modified example of the second embodiment of the present disclosure;

FIG. 6 is a view illustrating the fitting state of a gear damper according to the modified example of the second embodiment of the present disclosure; and

FIG. 7 is an external view of a gear damper according to a third embodiment of the present disclosure.

### DETAILED DESCRIPTION

Hereinafter, with reference to the drawings, modes for carrying out the present disclosure will be exemplarily described in detail on the basis of embodiments. However, the dimensions, materials, shapes, their relative arrangements, or the like of components described in the embodiments will not intend to limit the scope of the present disclosure unless otherwise specifically described.

### First Embodiment

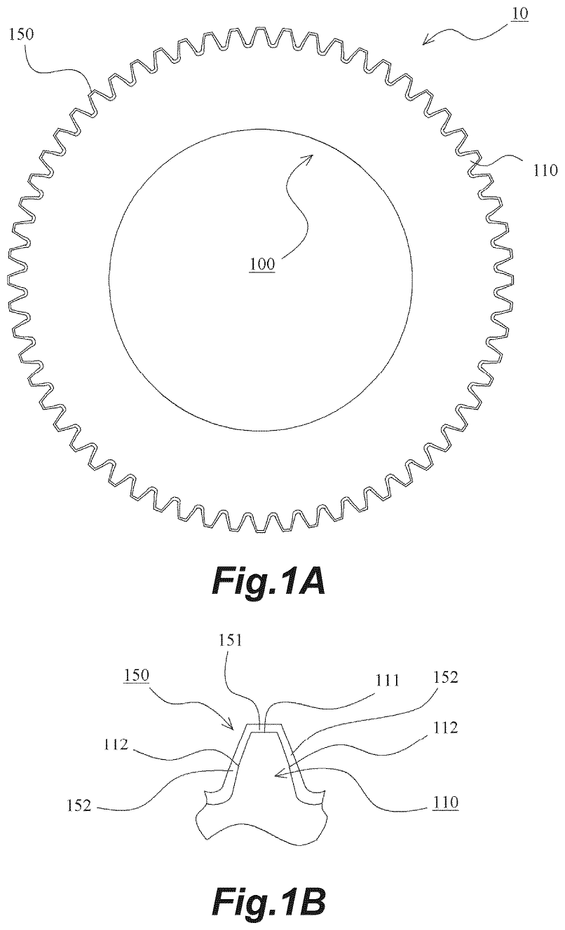

With reference to FIGS. 1A and 1B, a gear according to a first embodiment of the present disclosure will be described. FIGS. 1A and 1B are external views of the gear according to the first embodiment of the present disclosure. FIG. 1A is a front view of the gear, and FIG. 1B is an enlarged view illustrating the vicinity of a tooth in FIG. 1A.

A gear 10 according to this embodiment is composed of a metal gear body 100 having a plurality of teeth 110 and a damper unit 150. The damper unit 150 is provided to cover at least the meshing surface of each of the teeth 110 in the gear body 100 and has a surface made of an elastic body. Note that, needless to say, the gear 10 is configured to mesh with the teeth of other gears, and the “meshing surfaces” refer to surfaces that mesh with the teeth of other gears.

The teeth 110 have a tip end surface 111 and lateral surfaces 112 on both sides of the tip end surface 111. In this embodiment, the configuration where the damper unit 150 is provided to cover the entire tip end surfaces 111 and the lateral surfaces 112 is employed. However, as described above, the damper unit 150 only needs to be provided to cover at least the meshing surfaces.

The damper unit 150 according to this embodiment is composed of a rubber layer provided on the surfaces of the meshing surfaces. More specifically, the damper unit 150 is composed of a first rubber layer 151 that covers the tip end surfaces 111 of the teeth 110 and a second rubber layer 152 that covers the lateral surfaces 112 on both sides of the teeth 110.

The damper unit 150 may be formed by applying rubber glue to the meshing surfaces of the teeth 110 and then allowing the rubber glue to dry. Further, the damper unit 150 may also be formed by applying rubber glue to the meshing surfaces of the teeth 110, allowing the rubber glue to dry, and then vulcanizing the rubber glue through heating. The rubber glue may be obtained, for example, by dissolving the material of IIR high-damping rubber in toluene. This rubber glue only needs to be applied to the tip end surfaces 111 and the lateral surfaces 112 on both sides of the teeth 110 with a thickness of approximately 1 mm or less and then dried, or it only needs to be dried and then heated for vulcanization. Note that the rubber glue may also be applied by spraying or brushing. Further, it is preferable to prevent the rubber glue from separating by applying adhesive to the tip end surfaces 111 and the lateral surfaces 112 on both sides of the teeth 110 before applying the rubber glue. Note that the adhesive may also be applied to the tip end surfaces 111 and the lateral surfaces 112 on both sides of the teeth 110 by spraying.

When the rubber glue is dried and then heated for vulcanization, the gear body 100 to which the rubber glue has been applied only needs to be placed, for example, in a furnace at a temperature of 150° C. or higher and 250° C. or lower and baked for approximately 0.5 minutes or more and 30 minutes or less.

According to the gear 10 configured as described above, the damper unit 150 composed of the rubber layer is provided on the meshing surfaces of the teeth 110, enabling the absorption of shock caused when the teeth come into contact with each other during meshing with other gears. As a result, it is possible to reduce the generation of noise. Further, the damper unit 150 is configured only by providing the rubber layer on the meshing surfaces of the teeth 110. Therefore, the configuration of the damper unit 150 is simple. This configuration offers excellent versatility since the damper unit may be provided on various gears. Note that this embodiment describes the case of a so-called flat gear as illustrated in FIGS. 1A and 1B, but the present disclosure is applicable to various gears. That is, a damper unit made of a rubber layer as described above only needs to be provided on the surfaces of the teeth of various gears.

### Second Embodiment

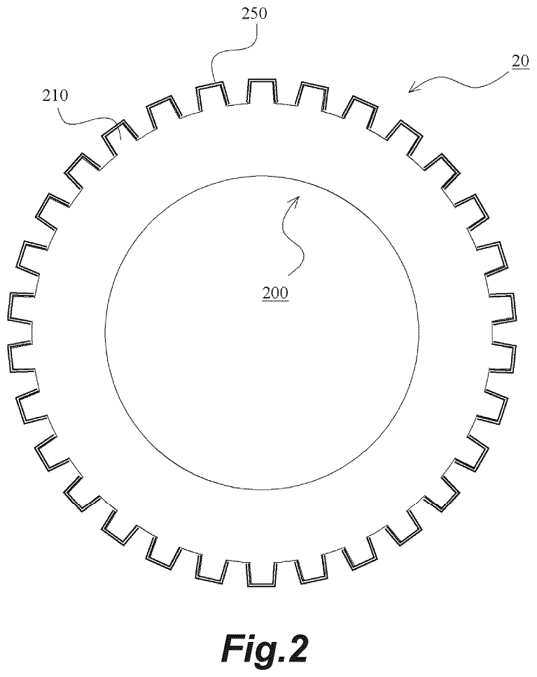

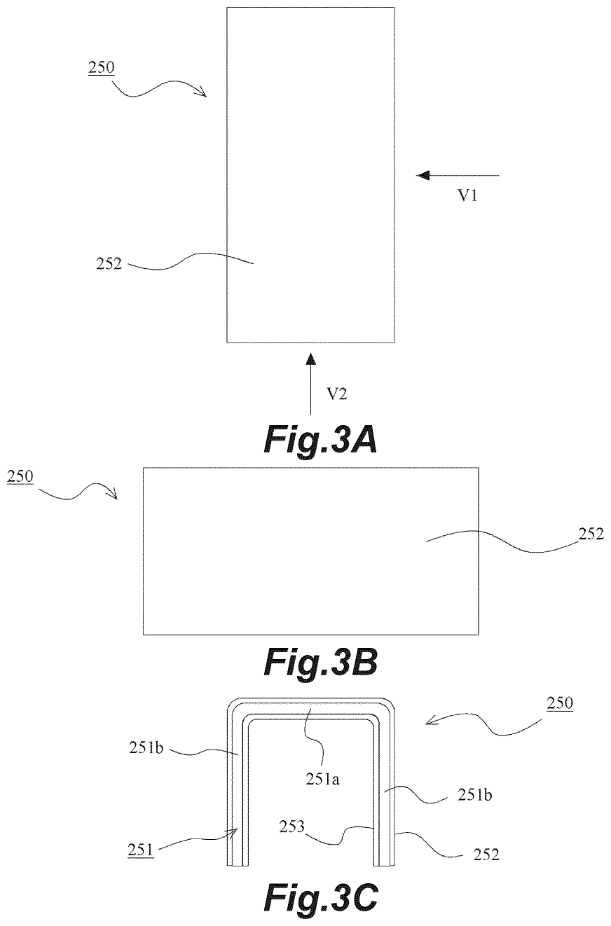

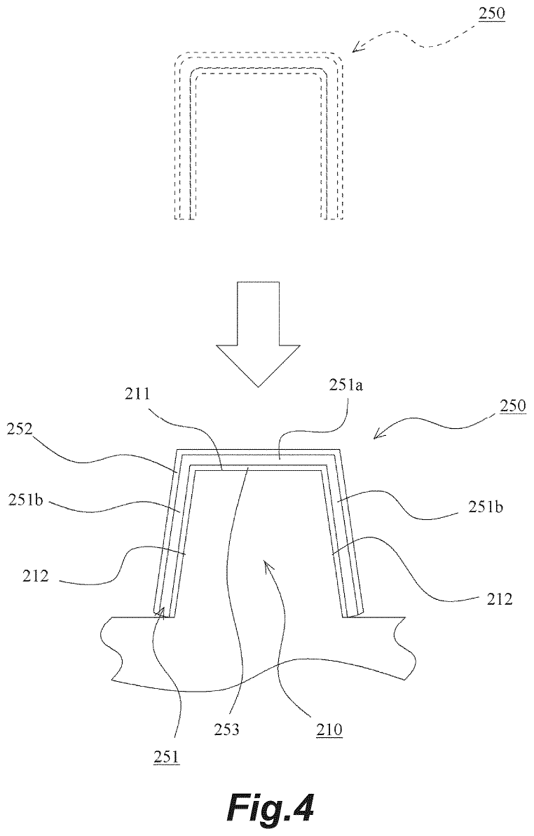

In FIGS. 2 to 4, a second embodiment of the present disclosure is illustrated. FIG. 2 is an external view of a gear according to the second embodiment of the present disclosure and is a front view of the gear. FIGS. 3A to 3C are external views of a gear damper according to the second embodiment of the present disclosure. FIG. 3A is a plan view of the gear damper, FIG. 3B is a view as viewed in an arrow V1 direction in FIG. 3A, and FIG. 3C is a view as viewed in an arrow V2 direction in FIG. 3A. FIG. 4 is a view illustrating the fitting state of the gear damper according to the second embodiment of the present disclosure.

A gear 20 according to this embodiment is composed of a metal gear body 200 having a plurality of teeth 210 and a damper 250 serving as a damper unit like the first embodiment. In this embodiment as well, the damper 250 is provided to cover at least the meshing surface of each of the teeth 210 in the gear body 200 and has a surface made of an elastic body like the first embodiment.

The teeth 210 have a tip end surface 211 and lateral surfaces 212 on both sides of the tip end surface 211. In this embodiment, the configuration where the damper 250 is provided to cover the entire tip end surface 211 and the lateral surfaces 212 is employed. However, as described above, the damper 250 only needs to be provided to cover at least the meshing surface.

The damper 250 according to this embodiment refers to a damper member fitted and fixed to each of the teeth 210. The damper 250 is composed of a thin plate unit 251 made of a metal thin plate and rubber layers provided on both surfaces of the thin plate unit 251. The rubber layers include a first rubber layer 252 on a surface side and a second rubber layer 253 that comes into contact with each of the teeth 210. Further, the thin plate unit 251 of the damper 250 includes a first thin plate unit 251a that covers the tip end surface 211 of each of the teeth 210 and second thin plate units 251b that cover the lateral surfaces 212 on both sides of each of the teeth 210.

The damper 250 configured as described above may be obtained by providing rubber layers on both surfaces of a metal thin plate and then forming the metal thin plate into a desired shape through thin plate working. Note that as a method for providing the rubber layers on both surfaces of the thin plate, the method described in the first embodiment where the rubber layer is provided on the surface of the gear body 100 may be, for example, employed.

As illustrated in FIG. 4, the damper 250 configured as described above may be fitted to each of the teeth 210 for fixation. In FIG. 4, the state of the damper 250 before fitting is indicated by dotted lines. Then, when the damper 250 is fitted to the tooth 210 in an arrow direction, a pair of the second thin plate units 251b deform, causing their tip ends to separate from each other. As a result, the damper 250 is fixed to the tooth 210. That is, the second rubber layer 253 is compressed, while the tooth 210 is held between the pair of second thin plate units 251b due to the elastic restoration force of the pair of second thin plate units 251b. As a result, the damper 250 is fixed to the tooth 210.

Note that in this embodiment, the damper member serving as the damper 250 is separately fitted and fixed to each of the teeth 210. That is, the number of the damper members serving as the dampers 250 needed corresponds to the number of the teeth 210 provided on the gear body 200.

According to the gear 20 configured as described above, the damper member serving as the damper 250 having the surface made of the elastic body (first rubber layer 252) is provided on the meshing surface of each of the teeth 210, enabling the absorption of shock caused when the teeth come into contact with each other during meshing with other gears. As a result, it is possible to reduce the generation of noise. Further, the damper member serving as the damper 250 only needs to be fitted to each of the teeth 210. As a result, it is possible to prevent the structure of the gear body from becoming complicated. This configuration offers excellent versatility since the damper unit may be provided on various gears. Note that this embodiment describes the case of a so-called flat gear as illustrated in FIG. 2, but the present disclosure is applicable to various gears. That is, the damper member serving as the damper 250 only needs to be provided on each of the teeth of various gears. Since the damper member may be formed into a desired shape by thin plate working as described above, it is easily applicable to various gears.

### Modified Example of Second Embodiment

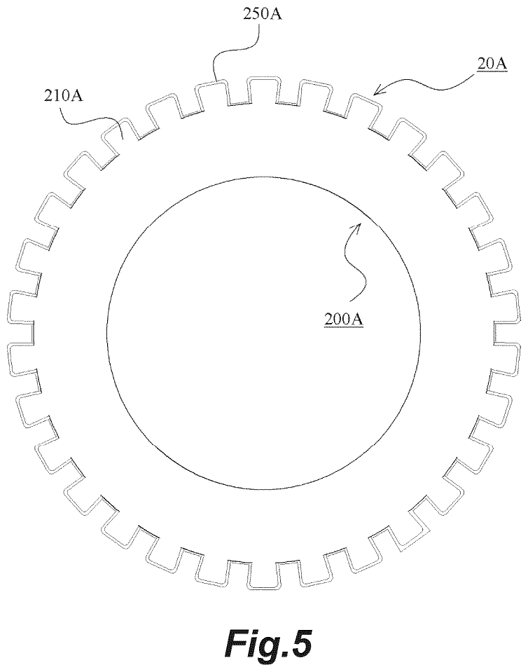

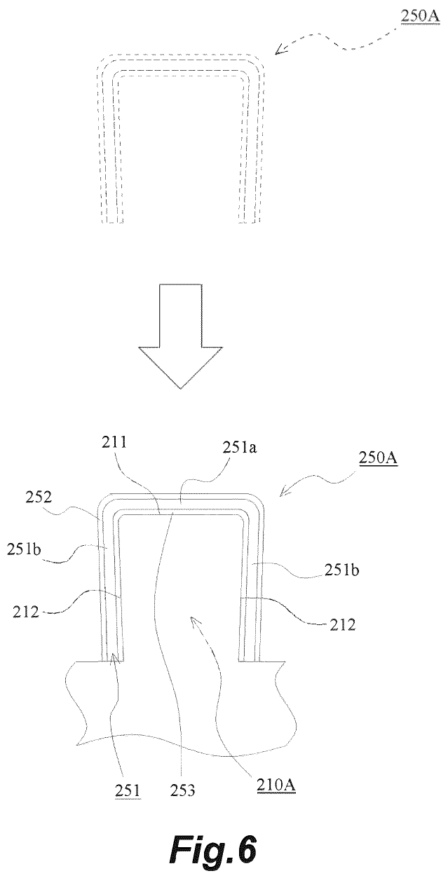

In FIGS. 5 and 6, a modified example of the second embodiment of the present disclosure is illustrated. FIG. 5 is an external view of a gear according to the modified example of the second embodiment of the present disclosure and is a front view of the gear. FIG. 6 is a view illustrating the fitting state of a gear damper according to the modified example of the second embodiment of the present disclosure. The basic configuration is the same as that of the second embodiment. Therefore, the same components will be indicated by the same symbols, and their descriptions will be omitted as needed.

As described above, in the gear 20 according to the second embodiment, the second rubber layer 253 is compressed, while the tooth 210 is held between a pair of the second thin plate units 251b due to the elastic restoration force of the second thin plate units 251b. As a result, the damper 250 is fixed to the tooth 210. However, depending on the materials or use environments of various members, there is a likelihood that the damper 250 disengages from the tooth 210 due to a centrifugal force or the like associated with the rotation of the gear 20.

In view of the above problem, this modified example will describe a configuration that makes it possible to prevent a damper from disengaging from a tooth.

A gear 20A according to this modified example is composed of a metal gear body 200A having a plurality of teeth 210A and a damper 250A serving as a damper unit like the second embodiment. In this modified example as well, the damper 250A is provided to cover at least the meshing surface of each of the teeth 210A in the gear body 200A and has a surface made of an elastic body like the second embodiment.

The teeth 210A according to this modified example have a tip end surface 211 and lateral surfaces 212 on both sides of the tip end surface 211. In the second embodiment, both the lateral surfaces 212 of each of the teeth 210 are configured so that the distance between both the lateral surfaces narrows toward the tip end surface 211 of the tooth 210 as illustrated in FIG. 4. Conversely, in this modified example, both lateral surfaces 212 of the teeth 210A are configured so that the distance between both the lateral surfaces increases toward the tip end surface 211 of each of the teeth 210A.

In this modified example as well, the configuration where the damper 250A is provided to cover the entire tip end surfaces 211 and the lateral surfaces 212 is employed. However, as described above, the damper 250A only needs to be provided to cover at least the meshing surfaces.

The damper 250A according to this modified example is also composed of a thin plate unit 251 made of a metal thin plate and rubber layers (first rubber layer 252 and second rubber layer 253) provided on both surfaces of the thin plate unit 251 like the second embodiment. Further, the thin plate unit 251 include a first thin plate unit 251a and second thin plate units 251b. The damper 250A is manufactured using the method described in the second embodiment.

As illustrated in FIG. 6, the damper 250A configured as described above may be fitted to each of the teeth 210A for fixation like the second embodiment. In FIG. 6, the state of the damper 250A before fitting is indicated by dotted lines. In this modified example, a pair of surfaces (corresponding to the inner surfaces of the second rubber layer 253 inside the second thin plate units 251b) of the damper 250A that face the lateral surfaces 212 of each of the teeth 210A are configured so that the distance between the pair of surfaces increases toward the tip end surface 211 of each of the teeth 210A.

In this modified example as well, the damper 250A is fixed to the teeth 210A when being fitted to the teeth 210A in an arrow direction. Note that in this modified example, it is desirable to form a larger chamfer (such as an R-surface having a large curvature radius) at the portions where the tip end surface 211 and the lateral surfaces 212 of each of the teeth 210A are connected to each other in order to facilitate a fitting operation for the damper 250A.

In the gear 20A configured as described above, the same effects as those of the second embodiment are obtained. In this modified example, both lateral surfaces 212 of the teeth 210A are configured so that the distance between both the lateral surfaces increases toward the tip end surfaces 211 of the teeth 210A, and a pair of surfaces of the damper 250A that face both the lateral surfaces 212 of the teeth 210A, respectively, are also configured so that the distance between the pair of surfaces increases toward the tip end surfaces of the teeth 210A. As a result, even if a force is applied to the damper 250A in the direction where the damper 250A disengages from the teeth 210A, the pair of surfaces become caught on both the lateral surfaces 212 of the teeth 210A, respectively. Accordingly, it is possible to prevent the damper 250A from disengaging from the teeth 210A.

### Third Embodiment

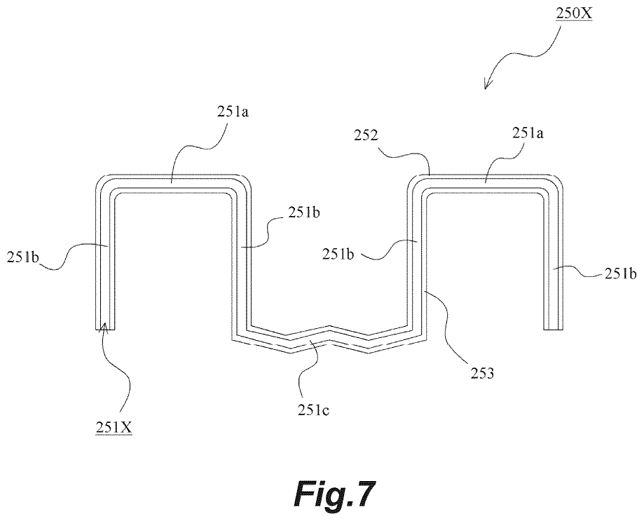

In FIG. 7, a third embodiment of the present disclosure is illustrated. In the above second embodiment, the case is described where the damper (damper member) is configured to be separately fitted and fixed to each of the teeth. Conversely, this embodiment will describe the configuration in a case where a damper has a plurality of fitting units that are collectively fitted and fixed to a plurality of teeth. Other configurations and operations are the same as those of the second embodiment. Therefore, the same components will be indicated by the same symbols, and their descriptions will be omitted as needed.

FIG. 7 is an external view of a gear damper according to the third embodiment of the present disclosure and is a front view of the gear damper. A damper 250X according to this embodiment refers to a damper member that is fitted and fixed to teeth. Since the teeth and a gear body are as described in the second embodiment, their descriptions will be omitted.

The damper 250X is composed of a thin plate unit 251X made of a metal thin plate and rubber layers that are provided on both surfaces of the thin plate unit 251X like the second embodiment. The rubber layers include a first rubber layer 252 on a surface side and a second rubber layer 253 that comes into contact with the teeth like the second embodiment. Further, the thin plate unit 251X of the damper 250X includes a first thin plate unit 251a that covers the tip end surface of each of the teeth and second thin plate units 251b that cover the lateral surfaces on both sides of each of the teeth.

The damper 250X serving as the damper member according to this embodiment has a plurality of fitting units that are collectively fitted and fixed to a plurality of teeth. That is, as illustrated in FIG. 7, the damper 250X has a pair of the first thin plate units 251a and a pair of the second thin plate units 251b on both sides of each of the first thin plate units 251a. As a result, it is possible to fit the fitting units, which include the first thin plate units 251a and a pair of the second thin plate units 251b on both sides of the first thin plate units 251a, to two teeth. Further, in this embodiment, an expansion/contraction unit that enables the slight adjustment of a mutual distance is provided between the adjacent fitting units. In this embodiment, the thin plate unit 251X has an accordion-shaped unit 251c, and the accordion-shaped unit 251c functions as the expansion/contraction unit. That is, the expansion/contraction of the accordion-shaped unit 251c enables the slight adjustment of the distance between the fitting units on both sides of the accordion-shaped unit 251c.

In the case where the damper 250X configured as described above is employed, it is possible to obtain the same effects as those of the second embodiment. Further, in the case where the damper 250X according to this embodiment is employed, it is possible to reduce the number of the dampers 250X needed for one gear compared to the second embodiment. Of course, it is also possible to reduce the number of operation times for fitting the damper 250X. Further, the damper 250X offers excellent fitting operability with the accordion-shaped unit 251c even if the distance between adjacent teeth varies due to dimensional tolerance. Note that the damper 250X having the two fitting units is described as an example in this embodiment. However, a damper having three or more fitting units may also be employed. Further, the configuration described in the modified example of the second embodiment may also be employed in this embodiment.

This application claims the benefit of Japanese Patent Application No. 2023-138643, filed on Aug. 29, 2023, and Japanese Patent Application No. 2024-035222, filed on Mar. 7, 2024, which are hereby incorporated by reference herein in its entirety.

What is claimed is:

1. A gear comprising:
a metal gear body; and
a damper unit that is provided to cover at least a meshing surface of each of teeth in the gear body and has a surface made of an elastic body.

2. The gear according to claim 1, wherein
the damper unit is a rubber layer provided on a surface of the meshing surface.

3. The gear according to claim 2, wherein
the damper unit is the rubber layer formed by applying rubber glue to the meshing surface and then allowing the rubber glue to dry.

4. The gear according to claim 2, wherein
the damper unit is the rubber layer formed by applying rubber glue to the meshing surface, allowing the rubber glue to dry, and then vulcanizing the rubber glue through heating.

5. The gear according to claim 1, wherein
the damper unit is a damper member fitted and fixed to the tooth.

6. The gear according to claim 5, wherein
the damper member includes a thin plate unit made of a metal thin plate and rubber layers provided on both surfaces of the thin plate unit.

7. The gear according to claim 5, wherein
both lateral surfaces of the tooth are configured so that a distance between both the lateral surfaces increases toward a tip end surface of the tooth, and a pair of surfaces of the damper member that face both the lateral surfaces of the tooth are configured so that a distance between the pair of surfaces increased toward the tip end surface of the tooth.

8. The gear according to claim 5, wherein
the damper member is individually fitted and fixed to each of the teeth.

9. The gear according to claim 5, wherein
the damper member has a plurality of fitting units that are collectively fitted and fixed to a plurality of the teeth, and wherein
an expansion/contraction unit that enables slight adjustment of a mutual distance is provided between the fitting units adjacent to each other.

10. A gear damper fitted and fixed to a tooth in a metal gear body and provided to cover at least a meshing surface of the tooth, and having a surface made of an elastic body.

11. The gear damper according to claim 10, comprising
a thin plate unit made of a metal thin plate and rubber layers provided on both surfaces of the thin plate unit.

12. The gear damper according to claim 10, wherein
both lateral surfaces of the tooth are configured so that a distance between both the lateral surfaces increases toward a tip end surface of the tooth, and
a pair of surfaces that face both the lateral surfaces of the tooth are configured so that a distance between the pair of surfaces increases toward the tip end surface of the tooth.

13. The gear damper according to claim 10, wherein
the gear damper is individually fitted and fixed to each of the teeth.

14. The gear damper according to claim 10, further comprising
a plurality of fitting units that are collectively fitted and fixed to a plurality of the teeth, wherein
an expansion/contraction unit that enables slight adjustment of a mutual distance is provided between the fitting units adjacent to each other.
